(19) United States
(12) Patent Application Publication
(10) Pub. No.: US 2009/0168845 A1
(43) Pub. Date: Jul. 2, 2009

(54) HOPPED ULTRAWIDEBAND WIRELESS

(75) Inventors: Kris Fleming, Chandler, AZ (US); David Leeper, Scottsdale, AZ (US)

Correspondence Address: INTEL CORPORATION;c/o CPA Global, P.O. BOX 52050, MINNEAPOLIS, MN, 55402, US

(73) Assignee: INTEL CORPORATION, Santa Clara, CA (US)

(21) Appl. No.: 11/968,028

(22) Filed: Dec. 31, 2007

(51) Int. Cl. H04B 1/713

(52) U.S. Cl. 375/133; 375/E01.033

(57) ABSTRACT

In some embodiments a transceiver includes a quadrature phase-shift keying modulator and/or demodulator to transmit and/or receive a frequency-hopping ultrawideband radio signal. Other embodiments are described and claimed.

### TECHNICAL FIELD

The inventions generally relate to hopped ultrawideband (HUWB) wireless.

### BACKGROUND

Ultrawideband (UWB) is an emerging wireless personal area network (WPAN) technology offering high speed data transmission over a short range. The current UWB standard (WiMedia 1.X or Ecma-368) offers speeds from 53.3 Mbps to 480 Mbps. However, it has become apparent to the inventors that some prospective users of UWB technology would actually prefer speeds below 53.3 Mbps for small battery-powered devices, particularly if those speeds could be provided at a lower cost and with substantially lower power consumption.

Bluetooth™ wireless technology already offers lower speeds at a lower power, but the current top speed of Bluetooth is 3 Mbps. Therefore, a need has arisen for UWB-based data speed between 3 Mbps and 53.3 Mbps that dramatically reduces power consumption and silicon cost relative to WiMedia (Ecma-368) solutions and maintains a close compatibility with WiMedia solutions.

### BRIEF DESCRIPTION OF THE DRAWINGS

The inventions will be understood more fully from the detailed description given below and from the accompanying drawings of some embodiments of the inventions which, however, should not be taken to limit the inventions to the specific embodiments described, but are for explanation and understanding only.

FIG. 1 illustrates a prior art transceiver.

FIG. 2 illustrates a transceiver according to some embodiments of the inventions.

FIG. 3 illustrates a frequency map according to some embodiments of the inventions.

FIG. 4 illustrates a frequency map according to some embodiments of the inventions.

FIG. 5 illustrates a sequence according to some embodiments of the inventions.

### DETAILED DESCRIPTION

Some embodiments of the inventions relate to hopped ultrawideband (HUWB) wireless.

In some embodiments a transceiver includes a quadrature phase-shift keying (QPSK) modulator and/or demodulator to transmit and/or receive a frequency-hopping ultrawideband (HUWB) radio signal.

In some embodiments modulating and/or demodulating uses quadrature phase-shift keying (QPSK) to transmit and/or receive a frequency-hopping ultrawideband (HUWB) radio signal.

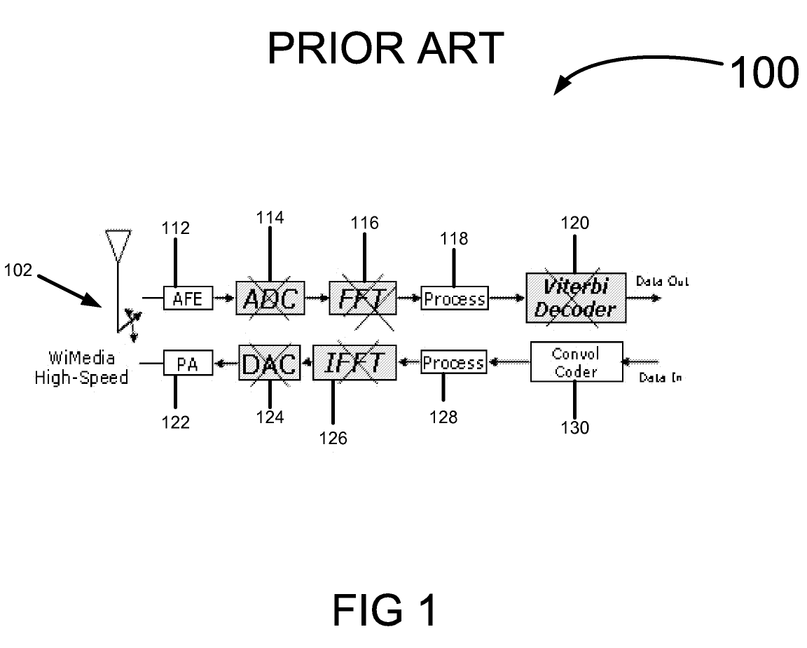

FIG. 1 illustrates a prior art transceiver 100. Transceiver 100 includes a switch 102 coupled to a radio, for example, to switch between a transmitter function and a receiver function of the transceiver. Transceiver 100 includes at a receiver side an analog front end (AFE) 112, an analog to digital converter (ADC) 114, a Fast Fourier Transform (FFT) 116, a process block 118, and a Viterbi decoder 120 to provide a data out signal. Transceiver 100 includes at a transmitter side a power amplifier (PA) 122, a digital to analog converter (DAC) 124, an Inverse Fast Fourier Transform (IFFT) 126, a process block 128, and a convolution coder 130 to code and transmit a data-in signal.

FIG. 1 illustrates a high level block diagram of transceiver 100. Transceiver 100 is a prior art WiMedia orthogonal frequency division multiplexing (OFDM) UWB transceiver (for example, a WiMedia MB-OFDM UWB transceiver). Transceiver 100 uses an over-the-air speed of 640 Mcps (mega-chips per second) at all times. Data speeds offered to the Media Access Control (MAC) layer run from 480 Mbps to 53.3 Mbps. Code, time, and frequency spreading are used to provide those speeds so that the lower the speed, the higher the margin against noise and interference. However, since the over-the-air speed is always 640 Mcps, the blocks marked in FIG. 1 with an “X” (that is, ADC 114, FFT 116, Viterbi decoder 120, DAC 124, and IFFT 126) draw full power no matter what the data speed. Additionally, it is noted that the ADC 114 and the DAC 124 used in FIG. 1 are power-hungry high-speed six-bit ADC/DACs commonly used for WiMedia 1.X. Therefore, transceiver 100 is unattractive for low data-speed applications that require reduced power consumption.

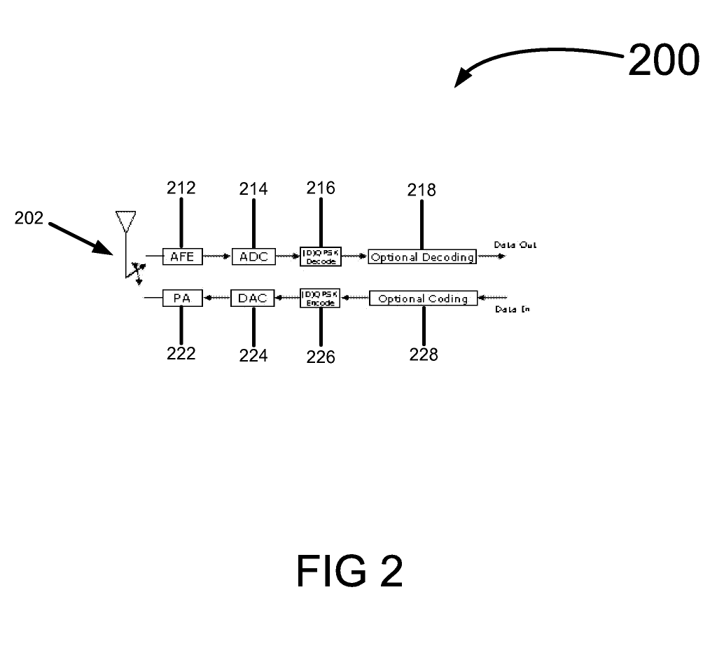

FIG. 2 illustrates a transceiver 200 according to some embodiments. In some embodiments, transceiver 200 includes a switch 202 coupled to a radio, for example, to switch between a transmitter function and a receiver function of the transceiver. Transceiver 200 includes at a receiver side an analog front end (AFE) 212, an analog to digital converter (ADC) 214, a differential quadrature phase-shift keying (DQPSK) decoder 216, and an optional decoding block 218 to provide a data out signal. Transceiver 200 includes at a transmitter side a power amplifier (PA) 222, a digital to analog converter (DAC) 224, a differential quadrature phase-shift keying (DQPSK) encoder 226, and an optional encoding block 228 to transmit a data-in signal. In some embodiments the DQPSK encoder 226 and the DQPSK decoder 216 may also be a QPSK encoder and QPSK decoder, respectively.

In some embodiments, transceiver 200 is a Hopped Ultrawideband (HUWB) transceiver. HUWB is a frequency-hopping, single carrier radio using QPSK or DQPSK modulation. In some embodiments, the hopping frequencies are deliberately chosen so that the HUWB “steals” one carrier per OFDM symbol from the specified set of sub-carriers in the Ecma-368 standard, for example. In some embodiments, the duration and timing of each hopped carrier is chosen to match exactly the 242.42 ns duration of the WiMedia symbol. The resulting signal causes minimal degradation to any existing WiMedia transmissions because the spectral nulls in the hopped-carrier signal appear at the center frequencies of all the WiMedia sub-carriers.

An HUWB transceiver such as transceiver 200 offers a dramatic power reduction over WiMedia 1.X because no FFT and/or IFFT engine is required and the transceiver may use a low speed (for example, one bit or two bit) ADC 214 and/or DAC 224 as opposed to the power hungry high-speed six bit ADC 114 and/or DAC 124 commonly used for WiMedia 1.X.

In some embodiments, differential coherent detection of QPSK modulation is implemented. This further simplifies the transceiver 200 by avoiding the need for complex channel equalization.

In some embodiments, more than one carrier is “stolen” per symbol and/or higher-order modulation of each carrier is implemented. This offers higher data speeds (but at a reduced range or higher power and cost).

In some embodiments, a Viterbi decoder such as that commonly used in a WiMedia implementation is made to be an optional item, which further reduces power and cost.

In some embodiments, channel equalization is implemented which allows for coherent detection and slightly higher margins against noise.

In some embodiments, a low-power frequency-hopping UWB radio is implemented that is coexistent and/or compatible with WiMedia 1.X and/or Ecma-368 OFDM technology. However, in some embodiments, a frequency hopper is used that is compatible with any OFDM-based technology, including but not limited to, for example, IEEE 802.11 wireless series, Digital Subscriber Line, Power Line, etc.

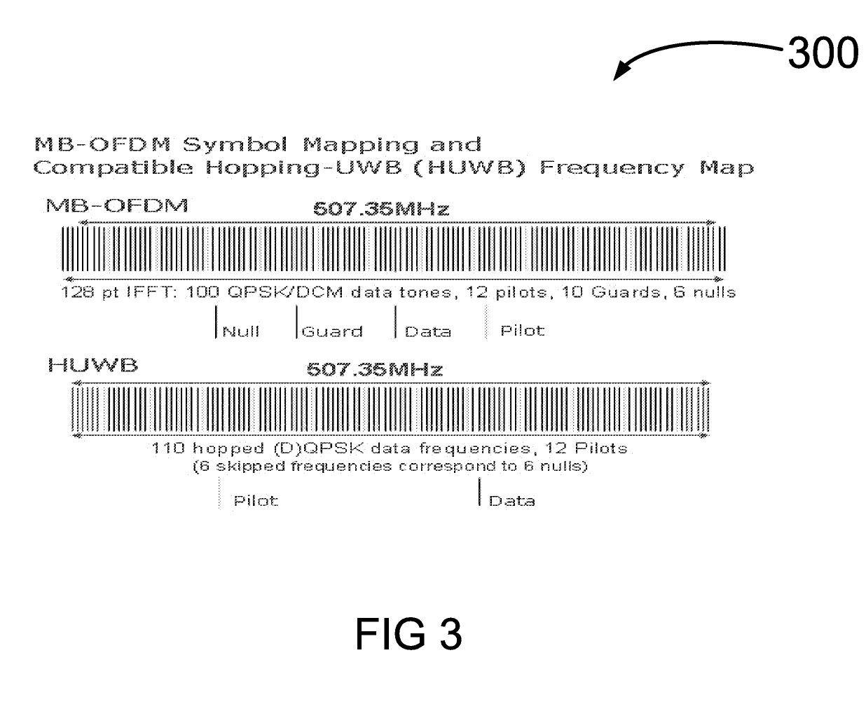

FIG. 3 illustrates a frequency map 300 according to some embodiments. Frequency map 300 illustrates an MB-OFDM symbol mapping and a compatible hopping UWB (HUWB) frequency map according to some embodiments.

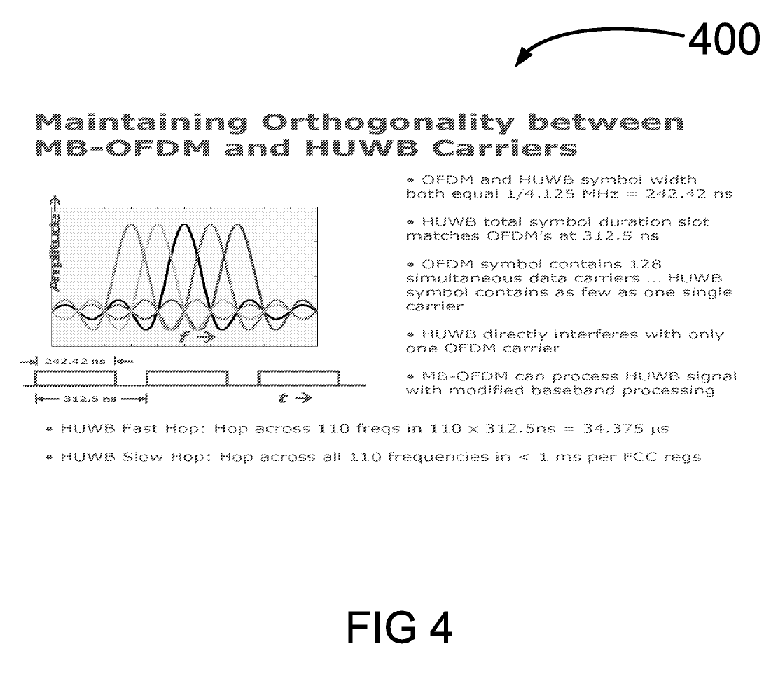

FIG. 4 illustrates a frequency map 400 according to some embodiments. Frequency map 400 illustrates an amplitude vs. frequency diagram and a timing diagram designed to maintain orthogonality between MB-OFDM and HUWB carriers. In some embodiments, OFDM and HUWB symbol width are both equal to 1/4.125 MHz=242.42 ns. In some embodiments, HUWB total symbol duration slot matches that of OFDM at 312.5 ns. In some embodiments, the OFDM symbol contains 128 simultaneous data carriers and the HUWB symbol contains as few as one single carrier. In some embodiments, HUWB interferes with only one OFDM carrier in any given OFDM symbol. In some embodiments, MB-OFDM can process the HUWB signal with modified baseband processing. In some embodiments, the HUWB fast hop hops across 110 frequencies in 110×312.5 ns=34.375 us. In some embodiments, the HUWB slow hop hops across all 110 frequencies in less than 1 ms per FCC regulations.

In some embodiments, UWB-based data speeds are provided between 3 and 53.3 Mbps, and power consumption and silicon cost relative to WiMedia (Ecma-368) solutions are dramatically reduced while maintaining close compatibility with WiMedia solutions. Power is reduced for data speeds below 53.3 Mbps while maintaining the close compatibility and using a full-speed design.

FIG. 2, FIG. 3 and FIG. 4 illustrate how a compatible hopped UWB (HUWB) transceiver is created in some embodiments. HUWB is compatible with WiMedia and/or OFDM implementations in the sense that the hopped carrier frequencies and symbol duration match exactly the frequencies and symbol duration for WiMedia MB-OFDM. The resulting signal can therefore be processed by either an HUWB transceiver or a WiMedia MB-OFDM transceiver. Additionally, in some embodiments, the spectrum of every hopped carrier will have spectral nulls corresponding to the frequencies of all other hopped carriers and OFDM sub-carriers. This makes the hopped carriers orthogonal to all other hopped or OFDM carriers, thereby reducing interference to or from those carriers. This is described herein as being “coexistence compatible”.

In some embodiments a HUWB transceiver design using a hopped single carrier (for example, using transceiver 200 illustrated in FIG. 2) eliminates the need for FFT and/or IFFT engines, and the need for a high speed and/or multi-bit ADC and/or DAC. In some embodiments, such a transceiver design also eliminates the need for a Viterbi decoder. These elements are the highest power-consumption elements in the prior art WiMedia OFDM transceiver 100.

In some embodiments, the single carrier is differential QPSK-modulated (DQPSK-modulated), resulting in two bits per symbol. Since the symbol rate is 3.2 Mbps, for example, in some embodiments the uncoded data speed is 6.4 Mbps. In some embodiments, a higher-order modulation may be implemented. For example, in some embodiments 8DPSK-modulation is used, resulting in a data speed of 9.6 Mbps. In some embodiments, more than one hopped carrier is used at a time, allowing data rates that are integer multiples of the above speeds, for example. In some embodiments, however, additional carriers require higher power consumption since additional mixers and/or filters may be required. Therefore, more than a small integer number of carriers may not be advantageous since the total power savings may vanish, making the original MB-ODFM design the more desirable option at some point.

In some embodiments, acquisition, timing, and clock frequency offset correction is handled in a similar manner as in WiMedia OFDM transceivers, allowing re-use of silicon design and coherent detection of the hopped carrier signals. In some embodiments, simpler acquisition circuits may be used and no clock correction circuitry is necessary if DQPSK is used. In some embodiments, pseudo-random hopping of the carrier frequencies is used. This minimizes the chance for collisions when multiple HUWB transceivers are operating in close proximity.

In some embodiments, HUWB transceivers and WiMedia UWB transceivers are able to communicate with one another even though WiMedia UWB transceivers use OFDM and HUWB transceivers do not. In some embodiments, in order to maintain synchronization, both HUWB transceivers and WiMedia UWB transceivers use the same “PLCP” preamble sequence in the Ecma-368 standard.

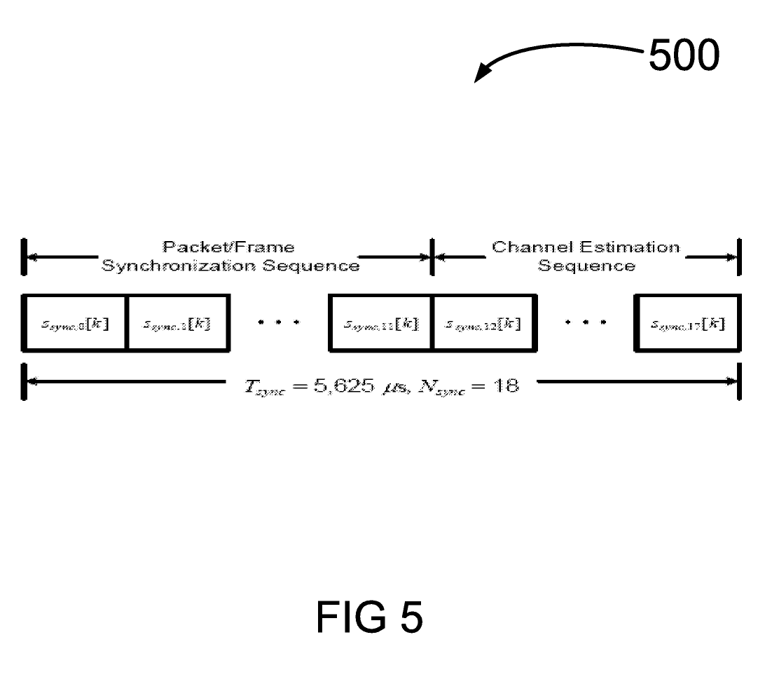

FIG. 5 illustrates a PLCP (physical layer conversion protocol) preamble sequence 500 from Ecma-368 according to some embodiments. As illustrated in FIG. 5, PLCP preamble sequence 500 includes a packet/frame synchronization sequence and a channel estimation sequence.

In HUWB implementations according to some embodiments, the packet/frame synchronization sequence is of the same form as used in WiMedia UWB, but the code set is extended to include codes for HUWB. In some embodiments, HUWB obtains its timing information in a manner identical to WiMedia UWB. This timing information, plus the phase correction information present in the pilot tones (for example, as illustrated in FIG. 3) allow a HUWB transceiver according to some embodiments to operate in a coherent, differentially coded, DQPSK modulation.

In WiMedia UWB, the channel estimation sequence contains a complex stored waveform used to train the OFDM transceiver. In HUWB according to some embodiments, this training is not necessary since the HUWB transceiver uses differential modulation (for example, DQPSK). In some embodiments, the six 312.5 ns segments of the channel estimation sequence are instead used to convey information normally found in the “Beacon Periods” in the WiMedia MAC, for example, and also are used to communicate hop sequence information. In this manner, HUWB can optionally be a member of a “Beacon Group” as described in the WiMedia MAC standard.

In some embodiments, by eliminating the need for FFT and/or IFFT engines required in OFDM implementations, and/or by employing one bit or two bit ADC and/or DAC subsystems in a transceiver, and/or by optionally eliminating a Viterbi decoder from the transceiver, HUWB offers 3 Mbps to 24 Mbps data transfer at far lower power than a full WiMedia OFDM implementation.

In some embodiments, by matching HUWB hopping frequencies to those of WiMedia OFDM subcarriers, and by using the same symbol durations as WiMedia OFDM symbols, HUWB offers minimal interference to WiMedia 1.X radios, since each hopped-frequency carrier is nominally orthogonal to all other WiMedia frequencies as well as other hopped carriers from HUWB radios.

In some embodiments, by transmitting only one single HUWB carrier instead of 100+ OFDM-based carriers, FCC regulations allow the average power on that single HUWB carrier to be as much as 20 dB higher than the individual carriers in OFDM. As a result, substantially longer range transmission is possible. It is noted, however, that peak power limitations, as defined by the FCC, may not allow a full 20 dB increase in some instances.

In some embodiments, a WiMedia transceiver can deliver high speed data transfer and simultaneously receive data from a lower-speed HUWB radio. This allows low power HID (Human Interface Device) or other devices to interwork with higher-speed, higher-power WiMedia radios. This allows a reduction in the number of radios that must be supported in laptops, desktops, ultra-mobile PCs (UMPCs), digital home platforms, and/or other platforms, which are becoming increasingly crowded with multiple wireless technologies.

In some embodiments, a low bit rate and/or low cost transceiver includes a far lower power consumption than a full ODFM implementation, while still maintaining compatibility with the full-speed OFDM-based implementation.

Although some embodiments have been described herein as being implemented in a certain manner, according to some embodiments these particular implementations may not be required.

Although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Some embodiments may be implemented in one or a combination of hardware, firmware, and software. Some embodiments may also be implemented as instructions stored on a machine-readable medium, which may be read and executed by a computing platform to perform the operations described herein. A machine-readable medium may include any mechanism for storing or transmitting information in a form readable by a machine (e.g., a computer). For example, a machine-readable medium may include read only memory (ROM); random access memory (RAM); magnetic disk storage media; optical storage media; flash memory devices; electrical, optical, acoustical or other form of propagated signals (e.g., carrier waves, infrared signals, digital signals, the interfaces that transmit and/or receive signals, etc.), and others.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

Although flow diagrams and/or state diagrams may have been used herein to describe embodiments, the inventions are not limited to those diagrams or to corresponding descriptions herein. For example, flow need not move through each illustrated box or state or in exactly the same order as illustrated and described herein.

The inventions are not restricted to the particular details listed herein. Indeed, those skilled in the art having the benefit of this disclosure will appreciate that many other variations from the foregoing description and drawings may be made within the scope of the present inventions. Accordingly, it is the following claims including any amendments thereto that define the scope of the inventions.

What is claimed is:

1. A transceiver comprising:
a quadrature phase-shift keying modulator and/or demodulator to transmit and/or receive a frequency-hopping ultrawideband radio signal.

2. The transceiver of claim 1, wherein the radio signal at any instant is a single carrier radio signal.

3. The transceiver of claim 1, wherein a frequency of the single carrier is hopped across a set of frequencies.

4. The transceiver of claim 1, wherein the quadrature phase-shift keying modulator and/or demodulator is a differential quadrature phase-shift keying modulator and/or demodulator.

5. The transceiver of claim 2, wherein the quadrature phase-shift keying modulator and/or demodulator is a differential quadrature phase-shift keying modulator and/or demodulator.

6. The transceiver of claim 1, further comprising a low speed and/or low bit rate analog to digital converter and/or a low speed and/or low bit rate digital to analog converter.

7. The transceiver of claim 1, wherein the quadrature phase-shift keying modulator and/or demodulator includes differential coherent detection of quadrature phase-shift keying.

8. The transceiver of claim 1, wherein the transceiver does not require a Viterbi decoder.

9. The transceiver of claim 1, wherein the transceiver does not require a Fast Fourier Transform engine or an Inverse Fast Fourier Transform engine.

10. The transceiver of claim 1, wherein the radio signal is compatible with orthogonal frequency-division multiplexing technology.

11. The transceiver of claim 1, wherein a spectrum of every hopped carrier will have spectral nulls corresponding to frequencies of all other hopped carriers and orthogonal frequency-division multiplexing sub-carriers.

12. The transceiver of claim 1, wherein hopped ultrawideband hopping frequencies are matched with those of WiMedia orthogonal frequency-division multiplexing sub-carriers.

13. The transceiver of claim 1, wherein same symbol durations are used as WiMedia orthogonal frequency-division multiplexing symbols.

14. The transceiver of claim 1, wherein the transceiver is a low bit rate, low cost, and/or low power consuming transceiver.

15. A method comprising:
modulating and/or demodulating using quadrature phase-shift keying to transmit and/or receive a frequency-hopping ultrawideband radio signal.

16. The method of claim 15, wherein the radio signal is, at any instant, a single carrier radio signal.

17. The method of claim 16, wherein a frequency of the single carrier is hopped across a set of frequencies.

18. The method of claim 15, wherein the quadrature phase-shift keying modulating and/or demodulating is differential quadrature phase-shift keying modulating and/or demodulating.

19. The method of claim 16, wherein the quadrature phase-shift keying modulating and/or demodulating is differential quadrature phase-shift keying modulating and/or demodulating.

20. The method of claim 15, further comprising analog to digital converting and/or digital to analog converting at a low speed and/or a low bit rate.

21. The method of claim 15, wherein the quadrature phase-shift keying modulating and/or demodulating includes differential coherent detection of quadrature phase-shift keying.

22. The method of claim 15, wherein the radio signal is compatible with orthogonal frequency-division multiplexing.

23. The method of claim 15, further comprising including a spectrum of every hopped carrier that has spectral nulls corresponding to frequencies of all other hopped carriers and orthogonal frequency-division multiplexing sub-carriers.

24. The method of claim 15, further comprising matching hopped ultrawideband hopping frequencies with those of WiMedia orthogonal frequency-division multiplexing sub-carriers.

25. The method of claim 15, further comprising using same symbol durations as WiMedia orthogonal frequency-division multiplexing symbols.

26. The method of claim 15, further comprising transmitting and/or receiving the radio signal at a low bit rate, a low cost, and/or a low power consumption.
